(19) United States
(12) Patent Application Publication
(10) Pub. No.: US 2006/0114336 A1
(43) Pub. Date: Jun. 1, 2006

(54) Method and apparatus for automatically attaching a location indicator to produced, recorded and reproduced images

(76) Inventor: Hang Liu, Ottawa (CA)

Correspondence Address: Hang Liu, 508-1129 Meadowlands Drive, Ottawa, ON, K3E 6J6, CA

(21) Appl. No.: 10/997,529

(22) Filed: Nov. 26, 2004

(51) Int. Cl. H04N 5/76

(52) U.S. Cl. 348/231.3; 348/239

(57) ABSTRACT

An apparatus that produces or records images, such as a camera, a video camera, a motion picture camera, a video recorder (also known as a camcorder), a digital camera, or a multifunctional cellular phone having still picture or video image capabilities, automatically attaches a location indicator to the produced or recorded images; an image reproducing apparatus, such as a video recording player, a video recorder with built-in LCD monitor, an image capable multifunctional cellular phone with image display LCD, automatically displays the attached location indicator.

### CROSS-REFERENCE TO RELATED APPLICATION

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING

Not Applicable.

### BACKGROUND OF THE INVENTION

1. Field of the Invention

This invention relates generally to image producing, recording and reproducing systems, in particular, to attaching a location indicator when producing or recording images, and displaying the location indicator when reproducing the images.

2. Description of the Related Art

Image recording devices include cameras that take still pictures, video recording devices that record video images, and motion picture cameras that make original movie footages, and further include multi-functional PDA (personal digital assistant), handheld computer, cellular phone and computers that have capability to record still and/or video images. The image recording devices may record the image on films, or may use photoelectric technology to transfer optical images into electronic signals and record the image signals on certain storage medium (e.g., magnetic tapes), or may further digitize the electronic image signals and store the digitized image signals onto digital storage devices (e.g., semiconductor memory, magnetic type, and optical disc). The digitized image signals may be further encoded before being stored in a storage medium, such as compressing encoding, encryption, etc. Collectively devices having such functionalities are referred to herein as “image recording devices”.

Image producing devices refer to equipment having capability of producing image signals for immediate transmission and/or display, without storing the images, such as video cameras for live TV broadcast, surveillance cameras for security monitoring, etc. In many cases, an image recording device also has the functionality of an image producing device.

Image reproducing devices include any devices that can reproduce the recorded images for displaying, such as photo developing and printing device, a video recorder that can show the images being recorded on its view finder, a video recorder that can replay the recorded video on its view finder or built-in screen, a digital camera that can show the image to be taken or taken on its view finder and/or built-in screen, a multi-functional PDA, handheld computer or cellular phone that can display images of still picture or video on its displaying device, a computer equipment with a monitor that can display the digitized photo or video, a printer that can print the image, a movie equipment that can show the movie on a screen, etc. Collectively devices having such functionalities are referred to herein as “image reproducing devices”.

Many image recording devices have the capability of recording the time information of the corresponding images, for example, producing a time indicator as a part of the image, or separately producing and storing the time information for future redisplay. Such time indicator usually is placed on the lower left or right corner of the images when being embedded into the image or when being redisplayed, and usually includes date (e.g., year, month and date) and/or time of day (e.g., hour, minute and second).

Location information is also an important piece of information associated with images being produced or recorded, therefore, there exists a need to create a method of attaching a location indicator information and redisplaying the indicator on the images.

Furthermore, time information is associated with location according to time zoon or political territory, for example, 8:00 a.m. in New York is not 8:00 a.m. in Paris, therefore, there also exists a need to improve the method of generating, recording and displaying the time indicator by automatically associating the time with location.

### BRIEF SUMMARY OF THE INVENTION

In one aspect, at least one embodiment of the invention provides a method of automatically attaching a location indicator to produced, recorded and/or reproduced images. The method comprises the steps of producing the images from physical objects by an image producing device or an image recording device; determining the location of said image producing device or image recording device; generating the location indicator according to said determined location; and, attaching the location indicator to said images.

The method may further includes a method of providing a more accurate location indicator by determining the location of said physical objects that are contents of the images, comprising the steps of determining the location of said image producing device or image recording device; determining the orientation of said image producing device or image recording device; determining the distance between said image producing device or image recording device and said physical objects; and calculating the location of said physical objects using said determined orientation, distance, and location of said image producing device or image recording device.

In another aspect, at least one embodiment of the invention provides an apparatus for automatically attaching a location indicator to produced images. The apparatus comprises an image generation means, generating images from physical objects; a location determination means, determining the location of said image generation means; a location indicator generator, coupled to said location determination means, translating said determined location to a location indicator content that represents the location; a location indicator attachment means, coupled to said image generation means and location indicator generator, for attaching said location indicator content to said images; and a controller, coupled to said image generation means, location determination means, location indicator generator and location indicator attachment means, for controlling and configuring the operation of said coupled functional modules.

The apparatus may further include a compass sensor, coupled to said location determination means and also coupled to said controller, for providing orientation information of said image generation means; a distance sensor, coupled to said location determination means, image generation means and controller, for providing information about distance between said image generation means and physical objects to be shoot into said images; the location determination means being further operative to obtain the information from said compass sensor and distance sensor; and calculate the location of said physical objects being shoot into images.

The apparatus may further include a location information database, coupled to said location indicator generator, for providing location information contents associated with said determined location.

The apparatus may further include a wireless transceiver, coupled to said location indicator generator and controller; and the wireless transceiver being operative to provide wireless access to, send queries to, and receive location information contents from a location information database or location information server connected to a network.

In another aspect, at least one embodiment of the invention provides a method of automatically providing a location indicator and time indicator to produced and/or recorded images, and automatically associating the time contents in the time indicator with the location information in the location indicator. The method comprises the steps of producing the images from physical objects by an image producing device or an image recording device; determining the location of said image producing device or image recording device; generating the location indicator according to said determined location; determining the time based on a clock that was set at a time zone; generating a local time by applying a time offset to the clock time according to the time difference of the time zoon and/or political territory associated with the location information in said location indicator and the time zoon where the clock was set; generating the time indicator according to said local time; and attaching the location indicator and time indicator to said images.

Other aspects of the invention will become clear thereafter in the detailed description of the preferred embodiments and the claims.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1 illustrates an example of time indicator on an image (prior art);

FIG. 2 illustrates an example of image including a location indicator in accordance with the invention;

FIG. 3 is a block diagram of an exemplary embodiment of an apparatus to produce a location indicator for produced or recorded images in accordance with the invention;

FIG. 4 is a block diagram of an exemplary embodiment of an apparatus to reproduce a recorded image having a location indicator in accordance with the invention;

FIG. 5 is a flow chart of the steps of method of producing or recording images that may include a location indicator, in a preferred embodiment;

The same reference numerals are used in different Figs. to denote similar elements.

### DETAILED DESCRIPTION OF THE INVENTION

It will be appreciated that in the description herein, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Furthermore, this description is not to be considered as limiting the scope of the invention, but rather as merely providing a particular preferred working embodiment thereof.

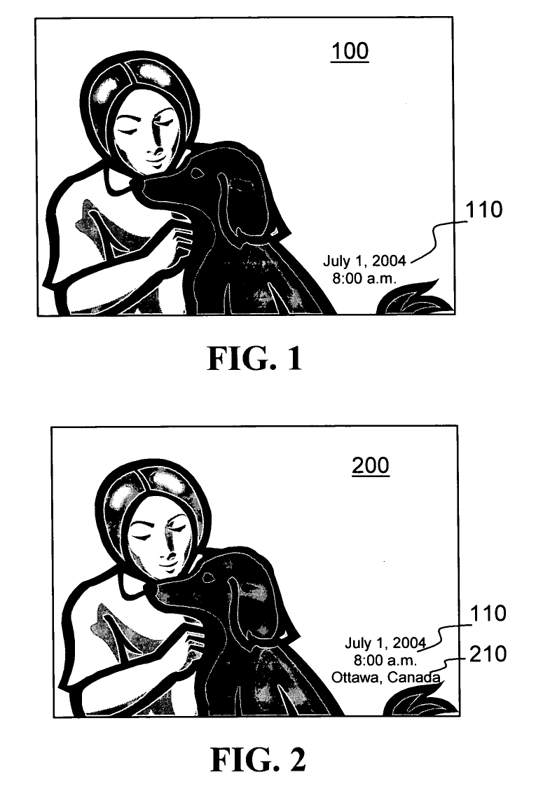

FIG. 1 illustrates a prior art example of time indicator on an image, such as an image of a still picture created by a digital camera. The image 100 that appears on the view finder before a picture is taken (recorded) may be displayed with a time indicator 110 located at certain position on the image, e.g., at the lower right corner as shown in the figure, and may allow a user to adjust its format and displaying position. After a picture is taken, the time indicator information is recorded onto the storage medium. Depending on the recording method of the time indicator information, when displaying the recorded image in a future time, the attributes associated with the time indicator 110 may be allowed to reconfigure. For example, if the time indicator information is recorded separately from the image information on the storage medium, when displaying, reconfigurations may be made to turn on or off the time indicator display, and may be allowed to reconfigure its displaying format. If the time indicator information is recorded as a part of the image information, it will be displayed with the image every time the image is reproduced.

FIG. 2 illustrates an example of image 200 that includes a location indicator 210 in accordance with the invention. The method and apparatus of this invention will enable a location indicator 210 and its associated information to be created and attached to the image, i.e., displayed and recorded while recording or immediate transmission, redisplayed when reproducing the image from recording, and may further be reconfigured when reproducing the image. The location indicator 210 may coexists with a time indicator 110, or may exists alone. The location indicator may be displayed as latitude and longitude, and may further include altitude; may also be displayed as town/city, province/state, and country, such as “Ottawa, ON, Canada”, or as name of point of attractions, such as, “Niagara Falls”.

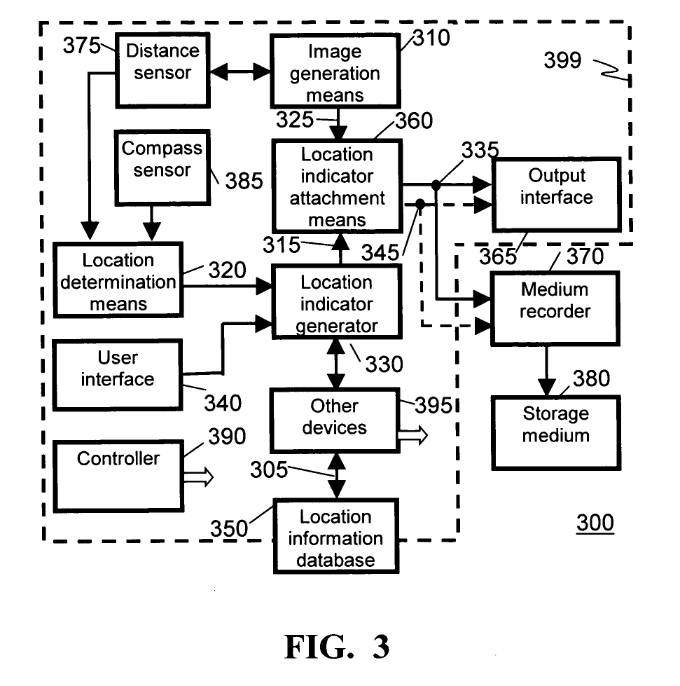

FIG. 3 is a block diagram of the apparatus to produce and attach a location indicator for produced or recorded images. According to one embodiment of this invention, functional blocks within the dashed line box 399 in the figure forms an image producing device 399 that supports a location indicator, comprising an image generation means 310, a location determination means 320, a user interface 340, a location indicator generator 330, a location indicator attachment means 360, an output interface 365, and a controller 390, and may further include a location information database 350, a compass sensor 385, a distance sensor 375, and other devices 395. The image producing device 399 can be used standalone, for instance, when the apparatus is used for producing TV image signals for immediate transmission. According to another embodiment of this invention, the functional blocks shown in the figure forms an image recording device 300 that can record images onto a storage medium, and may also producing an image signal 335 for immediate transmission, comprising the image producer 399, a medium recorder 370 and a storage medium 380. The apparatus is described in further detail next with each functional block.

The image generation means 310 generates the image for recording or for immediate transmission or display. The processing of the image generation means 310 may only involves optical processing such as that in an optical camera, or may further including photoelectric, analog and digital processing such as those in an analog video camera or in a digital camera. The image output 325 of image generation means 310, either in optical or electronic form, is provided to a location indicator attachment means 360 as will be described in further detail hereinafter. The associated technology for the image generation means 310 is well known in the art and does not need further explanation.

A location determination means 320 determines the location of the image producing device 399 or the image recording device 300. And more specifically, the location determination means 320 determines the location of the image generation means 310, and therefore, preferably the location determination means 320 is physically installed in close proximity of the image generation means 310. Note that, other functional blocks of image producing device 399 or the image recording device 300 may be physically apart from the image generation means 310 and the location determination means 320, depending on embodiment variations. The location determination means 320 may include a GPS (Global Positioning System) receiver, and/or receivers to work with other similar systems such as GLONASS (Global Navigation Satellite System), Galileo, or BEIDOU satellite positioning systems. Such receiver may work with multiple systems of navigation satellites. The position produced by the GPS receiver or the like may be in the form of latitude and longitude, and may further include altitude. In another embodiment, the location determination means 320 may be a wireless receiver, such as a cellular phone receiver that is capable of receiving the location information of the serving base station(s) broadcasted by overhead channels of the serving base station(s), and uses the base station's location as the approximate location of the image producing device 399 or the image recording device 300. In yet another embodiment, the location determination means 320 may be a wireless receiver or transceiver that is capable of determining location using wireless technology, such as a wireless receiver or transceiver working with base stations and associated servers in a wireless network to perform network based or hybrid network-and-handset based location determination. Such technology includes E-OTD (enhanced observed time difference), U-TDOA (uplink time difference of arrival), AFLT (advanced forward link triangulation), TDOA (time difference of arrival), TOA (time of arrival), AOA (angle of arrival), A-GPS (assisted GPS), propagation loss based, or the like. Optionally, when the location determination means 320 is not available, or it is out of service coverage and cannot produce a location at a give position, a user interface 340 may be used to prompt a user to manually input a location, or manually select a recent location that was produced by the location determination means 320 and stored in a memory (not shown in the figure). Determined location or a manually input/selected location is input to the location indicator generator 330 for generating the location indicator, as will be described next.

The location indicator generator 330 receiving the location information from the location determination means 320 or from the user interface 340 may further accept format configuration from user interface 340, e.g., selectively using latitude, longitude, and altitude, or selectively using city, province/state, and country, or using point of attraction, etc., and configure such attributes such as the position for displaying on image, character color, font, language, etc. The location indicator generator 330 may need to translate the raw location information (e.g., in latitude and longitude) to the nearest town/city name or point of attraction name by consulting a location information database 350 (to be described in more detail in the following paragraph). The contents of the location indicator produced by the location indicator generator 330 may be encoded as image signal 315 that is combined by the location indicator attachment means 360 with the image 325 produced by image generating means 310, or alternatively, encoded as certain formats of codes 315 to be attached to the image signal 325 by the location indicator attachment means 360 (to be further detailed later).

The location information database 350 may be a built-in database stored in a storage device of image producing device 399 or image recording device 300, which couples to 330 via an interface functionality of other devices block 395, or alternatively the location information database 350 may reside in a server of a network (not shown) that can be accessed, e.g., through wireless communication means, and the consultation to such server via link 305 may be through a wireless transceiver (as a functional module in the other devices block 395) that communicates to a wireless network. The latter case may be seen in a multifunctional cellular phone with image capabilities. Since the location information database 350 may or may not be a part of the image producing device 399 or image recording device 300, it is drawn half inside and half outside of the dashed line box 399. Furthermore, the device 399 or 300 may also consult to multiple location information databases 350, one may be a built-in unit, and some others may be servers over the network.

The location indicator attachment means 360 in one embodiment is an image combiner that combines image signal 325 from image generation means 310 and the image signal of the location indicator 315 from location indicator generator 330, and produces the combined image signal that overlays the location indicator 335. The combined image output 335 is sent to output interface 365 or medium recorder 370, ready for transmission, display or recording. Note that the combining may be performed electronically, and may also be performed optically. The latter case may be seen in a traditional optical camera that directly exposes to a film. The location indicator generator 330 in that optical case may produce light 315 for projecting the location indicator characters and it is combined with images from image generation means 310 (such as a lens) to be exposed onto a film. In another embodiment, the location indicator signal 315 produced by location indicator generator 330 is encoded in certain format, and the location indicator attachment means 360 associates the encoded location indicator signal 315 with corresponding image signals 325, and separately provides image signal 335 and location indicator signal 345 to output interface 365 and/or medium recorder 370. Such association may be accomplished by marking an ID number to the location indicator 315, and also embedding the ID at video session transition points of video stream 325. The association may also simply by directly passing image signals 325 as 335, and passing location indicator signal 315 as 345, simultaneously.

The medium recorder 370 accepts the combined image 335 that includes the location indicator image and record it onto the storage medium 380. Alternatively, the medium recorder 370 separately accepts image 335 and location indicator signal 345 that are associated with each other, and record them both onto the storage medium 380.

The other device block 395 may include such functional modules as a radio transceiver (e.g., a Bluetooth transceiver, a WLAN transceiver, and/or a cellular radio transceiver), an interface unit (such as a USB interface, a S-video interface, an IEEE 1394 interface), a LCD monitor, a light or flash light, a battery and power supply subsystem. In the case the image producing device 399 or image recording device 300 is a part of a multifunctional cellular phone, the other devices block 395 may further include audio devices such as a microphone and a speaker.

A controller 390 is coupled to all the functional elements of the image producing device 399 or image recording device 300 (for conciseness of the illustration, the coupling of controller 390 to the functional elements are not shown), and controls the functionality of each of the functional elements. As well known to those in the art, the controller may be built by a micro controller or a general purpose microprocessor with necessary memory device, a DSP (digital signal processor) device, or by logic circuits. Furthermore, some or all part of the functional elements of the image producing device 399 or image recording device 300, e.g., 310, 320, 330, 340, 350, 360, 370, 380 and 395 may be implemented by software running in the controller 390, and the coupling links between these elements may be via the controller 390, which is well known to those in the art.

The image generation means 310 may takes images of objects far away from the image producing device 399 or the image recording device 300, using a determined location of the image producing device 399 or the image recording device 300 to generate the location indicator contents may be inaccurate. For example, when a user stands at the Parliament Hill on the Ontario side of the Ottawa River to take a picture of the Civilization Museum on the Quebec side of the Ottawa River, the method may generate a wrong location indicator as “Parliament Hill, Ottawa, Ontario, Canada” instead of “Civilization Museum, Hull, Quebec, Canada”. Therefore, in an alternative embodiment, the image producing device 399 further includes a compass sensor 385, to determine the orientation of the image generation means 310, and further includes a distance sensor 375, producing the distance to the focused objects. The arts related to the compass sensor 385 and distance sensor 375 are well known that do not need further explanation. After determining the location of the image producing device 399 or the image recording device 300, the location determination means 320 further determines the location of the focused objects by offsetting the location of the image producing device 399 or the image recording device 300 by the amount of the reported distance in the direction of the reported orientation that are reported by the sensors 275 and 285, respectively.

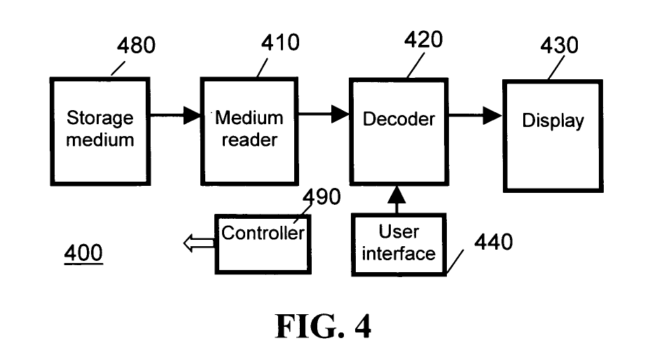

FIG. 4 is a block diagram of the image reproducing apparatus 400 for reproducing a recorded image with a location indicator. Contents stored in the storage medium 480 are read by a medium reader 410. If the location indicator was recorded as combined image, the encoded combined image signal read from the medium reader 410 is decoded by decoder 420, reproducing the image signal to be delivered to the display unit. If the images and the location indicators are encoded and recorded separately, the encoded image and encoded location indicator are read concurrently by the medium reader 410 and decoded concurrently by the decoder 420. If a configuration of location indicator attributes is also stored in the storage medium 480, the configuration of location indicator attributes is also read by the medium reader 410 and decoded by the decoder 420. The decoder 420 may further accept reconfiguration information from user interface 440 to reconfigure the attributes for displaying the location indicator, and produces combined image to be sent to the display unit. The reconfiguration from user interface 440 may include whether the location indicator is displayed, displaying position on the image, size, color, font, language, etc. When there exist more than one sources of configuration or reconfiguration of location indicator attributes, preferably they are used in accordance with the following priority, from high to low: 1) User reconfiguration received from user interface; 2) configuration stored in storage medium 480 that is read and decoded; 3) factory default configuration of apparatus 400. A controller 490 is coupled to all the functional elements of the image reproducing apparatus 400 (for conciseness of the illustration, the coupling of controller 490 to the functional elements are not shown), and controls the functionality of each of the functional elements. As well known to those in the art, the controller may be built by a micro controller or a general purpose microprocessor with necessary memory device, or by logic circuits. The image reproducing device 400 may be a combined apparatus with the image recording device 300, and in such case, the storage medium 480, user interface 440 and/or controller 490 may be shared by the corresponding parts of the functionalities with 380, 340 and 390, respectively.

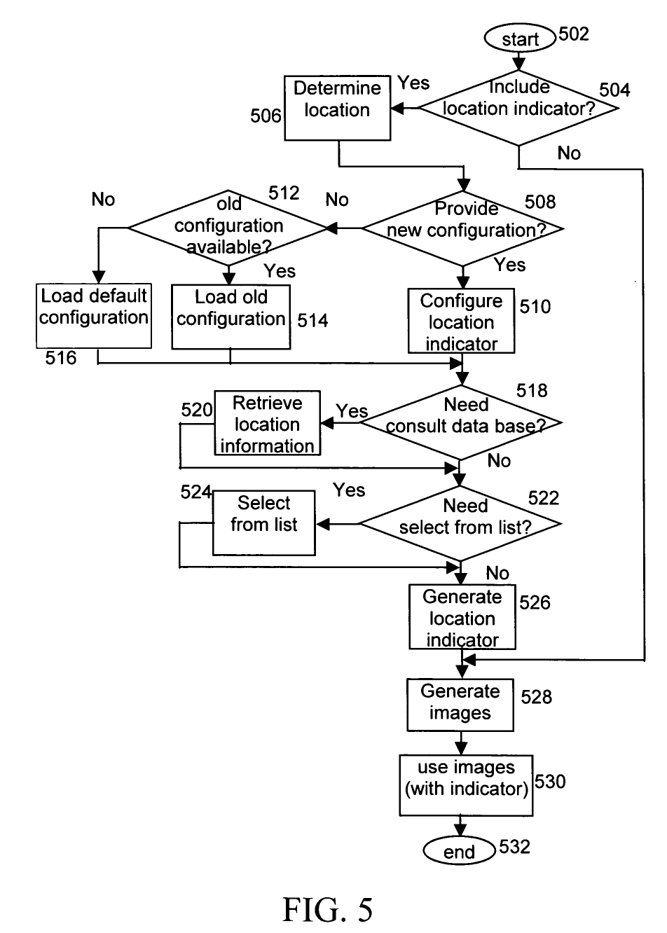

FIG. 5 is a flow chart of the steps of method of producing or recording images that may include a location indicator. Starting with step 502, the controller will check the device configuration at step 504 whether a location indicator should be included. If the answer is No, will proceed to step 528 as will be descried later. If the result is Yes, it performs step 506.

At step 506, the device location is determined such as in the form of latitude and longitude by means of GPS or wireless location technology, or alternatively in other forms and may be determined by a user input.

It then proceeds to step 508 where the processor checks whether a new format configuration for the location indicator is provided by a user. If the answer is Yes, at step 510 the processor performs the configuration of the location indicator according to the provided configuration information, and then proceeds to step 518 that will be described later; if the answer is No, the processor check whether an old user configuration was stored, at step 512. If the answer is Yes, the processor load the old user configuration and performs the configuration at step 514; if the answer is No, the processor loads at step 516 the default configuration that is stored in the memory. Either way, it proceeds to step 518 that will be described next.

At step 518, the processor checks whether the configuration received and performed requires to consult a location information database. For example, if the configuration received at step 510, 514 or 516 requires the use of the raw location information in the form of latitude and longitude, since the device already has the information determined at step 506, there is no need to consult a database. In such case, the answer is No. Otherwise, as another example, if the configuration received at step 510, 514 or 516 requires the use of the name of point of attractions, then there is a need to translate the raw location in latitude and longitude to the nearest point of attraction name, and a consultation to a database is necessary, with an Yes answer. If the answer obtained at step 518 is No, proceeds to step 522; if the answer is Yes, at step 520, a consultation to a database is made and the required location information is retrieved, such as through a wireless data access to a server in a network, or locally from the stored database in the device, then proceeds to step 522.

At step 522, the processor further checks whether the received location information contains multiple entries, i.e., a list, and needs a user to select from the list. If the answer is No, proceeds to step 526; if the answer is Yes, perform step 524 that prompts the user to make a selection. The user selection may select one entry, or may also select multiple entries. Then proceeds to step 526.

Step 526 performs the generation of the location indicator. It may encode the content characters as image signal to be combined with other images; it may also generate separately encoded location indicator signals. Either way, proceeds to step 528 as described next.

Step 528 generates the images of the still pictures, video or movie. The images may be accompanied with the location indicator according to the user configuration. The images may be further accompanied with other indications such as time and date indicator, moving speed indicator, moving direction indicator, temperature indicator. The time and date indicator may be automatically adjusted according to the location of the location indicator (shown or hidden) based on time zone and political territory it belongs to. The resulting images with or without a location indicator, according to the user configuration and produced by step 528, is now ready for use at step 530. The use includes recording, immediate transmission, or displaying. The process ends at step 532.

It should be understood that various modifications can be made to the embodiments described and illustrated herein, without departing from the invention, the scope of which is defined in the appended claims.

I claim:

1. A method of automatically attaching a location indicator to produced, recorded and/or reproduced images, comprising the steps of:
producing the images from physical objects by an image producing device or an image recording device;
determining the location of said image producing device or image recording device;
generating the location indicator according to said determined location; and
attaching the location indicator to said images.

2. The method recited in claim 1 wherein said produced, recorded and/or reproduced images include at least one member from the group consisting of:
still picture images;
video images;
motion picture images;
images exposed onto films and other photosensitive materials;
images presented by signals; and
images presented by data.

3. The method recited in claim 1 wherein said determination of location of said image producing device or image recording device is accomplished by at least one member method from the group consisting of:
a location determination method based on GPS;
a location determination method based on other navigation satellites;
a location determination method based on wireless technology;
using a nearby wireless network base station's location that are broadcasted by the base station as approximate location of said image producing device or image recording device;
a location that is manually input to said image producing device or image recording device by an operator of said device; and
an amendment to a location that is manually input to said image producing device or image recording device by an operator of said device.

4. The method of claim 1, further including a method of providing a more accurate location indicator by determining the location of said physical objects that are contents of said images, comprising the steps of:
determining the location of said image producing device or image recording device;
determining the orientation of said image producing device or image recording device;
determining the distance between said image producing device or image recording device and said physical objects; and
calculating the location of said physical objects using said determined orientation, distance, and location of said image producing device or image recording device.

5. The method of claim 1, wherein said generation of location indicator includes translating said determined location to contents of a character string that represents said location.

6. The method of claim 1, wherein said generation of location indicator further comprising consulting at least one location information database and/or location information server.

7. The method of claim 6, wherein said generation of location indicator further comprising selecting at least one item from a list of a plurality resulting items produced by said consulting to location information database and/or location information server.

8. The method of claim 1, wherein said attaching of the location indicator including producing an image by overlaying said original images with an image of said location indicator.

9. The method of claim 1, wherein said attaching of the location indicator including providing both said produced images and said location indicator signals and associating them with each other.

10. The method of claim 1, further comprising at least one step from the group of steps consisting of:
recording said images onto a storage medium;
recording said attached location indicators onto a/the storage medium;
recording a configuration of location indicator attributes onto a/the storage medium;
receiving a user reconfiguration of attributes of location indicators for reproduction of said location indicators;
configuring attributes of location indicators for reproduction in accordance with received, recorded or default configuration of location indicator attributes; and
reproducing said images and attached location indicators from said storage medium in accordance with configuration of location indicator attributes.

11. An apparatus for automatically attaching a location indicator to produced images, comprising:
an image generation means, generating images from physical objects;
a location determination means, determining the location of said image generation means;
a location indicator generator, coupled to said location determination means, translating said determined location to a location indicator content that represents the location;
a location indicator attachment means, coupled to said image generation means and location indicator generator, for attaching said location indicator content to said images; and
a controller, coupled to said image generation means, location determination means, location indicator generator and location indicator attachment means, for controlling and configuring the operation of said coupled functional modules.

12. The apparatus of claim 11, wherein said image generation means functions as at least one member from the group consisting of:
an optical still picture camera;
a digital still picture camera;
a video camera;
motion picture camera;
a device that produces images exposed onto films or other photosensitive materials;
a device that produces images presented by signals; and
a device that produces images presented by data.

13. The apparatus of claim 11, wherein said location determination means is at least one member from the group consisting of:
a GPS receiver;
a receiver similar to a GPS receiver that is capable of determining its location by receiving signals from at least one navigation satellite systems;
a wireless receiver that is capable of determining its location using wireless technologies;
a wireless transceiver that is capable of determining its location using wireless technologies;
a wireless receiver that can receive location information of a serving base station that is broadcasted by said base station of a wireless network;
a user interface that can input a location manually; and
a user interface that can input an amendment to a location manually.

14. The apparatus of claim 11, further comprising:
a user interface, coupled to said location indicator generator and also coupled to said controller, for accepting user configuration of location indicator attributes, and for user selection of and user amendment to said translated location indicator contents;
an output interface, coupled to said location indicator attachment means, providing image output with location indicator attached;
a medium recorder, coupled to said location indicator attachment means and also coupled to said controller, for recording said images and location indicator onto storage medium; and
a storage medium, coupled to said medium recorder, for storing contents of images and attached location indicator.

15. The apparatus of claim 11, further comprising:
a compass sensor, coupled to said location determination means and also coupled to said controller, for providing orientation information of said image generation means;
a distance sensor, coupled to said location determination means, image generation means and controller, for providing information about distance between said image generation means and physical objects to be shoot into said images;
the location determination means being further operative to
obtain the information from said compass sensor and distance sensor; and
calculate the location of said physical objects being shoot into images.

16. The apparatus of claim 11, further comprising:
a location information database, coupled to said location indicator generator, for providing location information contents associated with said determined location.

17. The apparatus of claim 11, further comprising:
a wireless transceiver, coupled to said location indicator generator and controller; and
the wireless transceiver being operative to provide wireless access to, send queries to, and receive location information contents from at least one location information database or location information server connected to a network.

18. The apparatus of claim 11, wherein said location indicator attachment means being operative to perform at least one of the functions in the group consisting of:
producing overlaid images of said original images and images of location indicator; and
providing both said original image signals and said location indicator signals and associating them with each other.

19. The apparatus of claim 11, further comprising:
a medium reader, coupled to said storage medium, for retrieving stored said images, attached location indicator and user configuration of location indicator attributes;
a decoder, coupled to said medium reader, user interface and controller;
a displaying device, coupled to said decoder, for displaying combined images with attached location indicators;
the decoder being operative to
decode images;
decode attached location indicator;
decode configuration of location indicator attributes if available;
accept a user reconfiguration if provided by a user, or use the decoded or default configuration of location indicator attributes; and
convert said decoded images and location indicator signals into combined image signals with attached location indicators for displaying, in accordance with said configuration or reconfiguration of location indicator attributes.

20. A method of automatically providing a location indicator and time indicator to produced and/or recorded images, and automatically associating the time contents in the time indicator with the location information in the location indicator, comprising the steps of:
producing the images from physical objects by an image producing device or an image recording device;
determining the location of said image producing device or image recording device;
generating the location indicator according to said determined location;
determining the time based on a clock that was set at a time zone;
generating a local time by applying a time offset to the clock time according to the time difference of the time zoon and/or political territory associated with the location information in said location indicator and the time zoon where the clock was set;
generating the time indicator according to said local time; and
attaching the location indicator and time indicator to said images.
